(19) United States
(12) Patent Application Publication
(10) Pub. No.: US 2026/0077408 A1
(43) Pub. Date: Mar. 19, 2026

(54) SYSTEM AND METHOD FOR RECYCLING OF REFRACTORY METAL POWDERS

(71) Applicant: PURDUE RESEARCH FOUNDATION, West Lafayette, IN (US)

(72) Inventors: Jeffrey P. Youngblood, Crawfordsville, IN (US); Ching-Chien Chen, West Lafayette, IN (US); Dina Khattab, West Lafayette, IN (US); Paul R. Mort, Lafayette, IN (US); Xiaoling Shen, West Lafayette, IN (US); Michael Shaw Titus, West Lafayette, IN (US)

(21) Appl. No.: 19/334,292

(22) Filed: Sep. 19, 2025

Related U.S. Application Data
(60) Provisional application No. 63/696,644, filed on Sep. 19, 2024.

(51) Int. Cl. B22F 10/73; B33Y 10/00

(52) U.S. Cl. CPC B22F 10/73; B33Y 10/00

(57) ABSTRACT

The present disclosure relates to a system and method for recycling an oxidized substrate, such as an oxidized refractory metal alloy. The recycling includes removing an oxidized material from an oxidized substrate. The system includes a processing chamber configured to provide an etched substrate from the oxidized substrate. The system may further include a processing gas, a gas inlet, a radiofrequency (RF) power supply, and a stage, such as a rotatable drum. The method includes generating a plasma from a processing gas, and contacting the oxidized substrate with the plasma.

### RELATED APPLICATIONS

This application claims the benefit of U.S. Provisional Application No. 63/696,644, filed Sep. 19, 2024, the entire disclosure of which is incorporated herein by reference.

### STATEMENT OF GOVERNMENT RIGHTS

This invention was made with government support under W912HQ-23-C-0046 awarded by the Department of Defense. The Government has certain rights in the invention.

### TECHNICAL FIELD

The disclosure generally relates to recycling systems and, more particularly, to recycling systems for refractory metal powders, for use in metal additive manufacturing processes.

### BACKGROUND

Refractory metals are a class of metals that are extraordinarily resistant to heat and wear. C103 is an extremely expensive refractory alloy used in aerospace applications, particularly in propulsion systems such as in rocket nozzles, where regenerative cooling is not available, and in other high temperature applications. Despite being fabricable through various means, the utilization of additive manufacturing (AM) for metal alloys is of high interest, showing potential in producing complex and optimized components from an array of materials with potential to decrease cost and lead time when compared to traditional manufacturing. Powder bed fusion (PBF) is an additive manufacturing, or 3d printing, technology that uses a heat source, such as a laser, to sinter or fuse atomized powder particles together. Like other additive processes this is performed one layer at a time until the part is completed. In high temperature processing, such as Laser Powder Bed Fusion (LPBF) techniques (Selective Laser Sintering (SLS), Selective Laser Melting (SLM), etc.), the high temperatures next to the part can oxidize the unused powder. Powders that have already been used in multiple builds often undergo severe oxidation, partial fusion, or melting near the laser interaction zone. Such degraded powders cannot be directly reused in additive manufacturing, as they would introduce defects in the final product. Instead, they must be fully remelted and reconditioned back into powder, which is a highly energy- and cost-intensive process.

Thus, there is a need to develop a powder reconditioning process that safely and cost-effectively removes oxygen-rich layers in refractory additive manufacturing (AM) powder.

Further areas of applicability will become apparent from the description provided herein. The description and specific examples in this summary are intended for purposes of illustration only and are not intended to limit the scope of the present disclosure.

### SUMMARY

In one aspect, the disclosure relates to a method of removing an oxidized material from an oxidized substrate comprising a base material and the oxidized material comprising:

generating a plasma from a processing gas; and

contacting the oxidized substrate with the plasma, thereby removing the oxidized material from the oxidized substrate to provide an etched substrate. The oxidized substrate may include a transition metal or an alloy thereof.

In another aspect, the disclosure relates to a system for removing an oxidized material from an oxidized substrate comprising a base material and the oxidized material comprising: a processing chamber configured to provide an etched substrate from the oxidized substrate, a gas inlet configured to supply a processing gas into the processing chamber, a radiofrequency (RF) power supply configured to supply radio-frequency power to an electrode and/or an inductive coil for generating a plasma from the processing gas, and a stage configured to hold the oxidized substrate. Each of the gas inlet, the RF power supply, the electrode, the inductive coil, and the stage may be independently coupled to the processing chamber. The oxidized substrate may include a transition metal or an alloy thereof.

### BRIEF DESCRIPTION OF THE FIGURES

FIG. 1A shows an image of a reactor processing chamber including an electrode (RF), a gas inlet, a vacuum inlet, a chamber vent, a Pirani vacuum gauge, and a drum (grounded).

FIG. 1B shows a schematic diagram of the rotatable drum, including powder disposed within, used in a processing chamber and the directionality/flow of gas, plasma, and electric field.

FIG. 2 shows TEM images of a C103 sheet oxidized at 300° C. for 1 h, a C103 sheet oxidized at 400° C. for 4 h, and a magnified image of the oxide layer.

FIG. 3A shows a TEM image of a C103 sheet oxidized at 400° C. for 4 h.

FIG. 3B shows a TEM image and STEM EDS mapping of the from FIG. 3A after 10 minutes of SF₆ etching. After plasma etching, oxide was removed, and a layer that is rich in fluorine (and hafnium) remained. Carbon and tungsten protective layers were applied on the top of the sample surface for FIB lift-out process.

FIG. 4A shows an SEM and TEM image of an oxidized C103 sheet after etching by SF₆ for 2 minutes.

FIG. 4B shows STEM HAADF images and EDS mapping of the etched C103 sheet from FIG. 4A.

FIG. 5A shows images of a C103 sheet oxidized at 400° C. for 4 h before etching (left), and the same sheet after etching with SF₆ for 210 seconds.

FIG. 5B shows SEM EDS mapping at the boundary of etched and un-etched areas of an oxidized C103 sheet after etching with SF₆ for 5 minutes.

FIG. 5C shows a graph of oxygen:metal ratio (O:Nb+Hf) versus etching time.

FIGS. 6A-D show the difference of composition change in bulk C103 oxides between SF₆ pure SF₆ and Ar mixed gas etching as measured by EDS. EDS atomic ratio of etched C103 surfaces using different gas chemistries. (FIGS. 6A,B) Oxygen-to-metal ratio (O:(Nb+Hf)) decreases with etching time inpure SF₆, SF₆ (20%) (6A)+Ar (80%) (6B), (FIGS. 6C,D) Fluorine-to-metal ratio (F:(Nb+Hf)) increases with time inpure SF₆ (d) SF₆ (20%)+Ar (80%) results in lower F:(Nb+Hf) ratios, indicating suppressed fluorination.

FIGS. 7A-C show ICP etch on bulk C103 oxides. FIGS. 7A, B shows the experiment conditions. FIG. 7C shows the atomic ratio for the different conditions listed in FIGS. 7A, B.

FIGS. 8A-C show ICP Etch Bulk C103 Oxides: Roughness Change. FIG. 8A shows the measured roughness change as a result of the different etch recipes. FIGS. 8B, C are images showing the roughness of the surface before and after etching.

FIG. 9 shows the etch parameters and recipes for the powder etching setup.

FIG. 10A shows electron micrographs of a C103 oversized powder oxidized at 400° C. for 1 h after a preclean cycle (Ar 5 sccm+H₂ 20 sccm) for 15 minutes to prepare the powder for etching.

FIG. 10B shows electron micrographs of a C103 oversized powder oxidized at 400° C. for 1 h after the preclean cycle of FIG. 10A, and after etching with SF₆ 5 sccm for 30 minutes.

FIG. 11A shows electron micrographs of a C103 oversized powder oxidized at 400° C. for 1 h after a preclean cycle (Ar+H₂) for 15 minutes, and etching (Ar 5 sccm+SF₆ 5 sccm) for 30 minutes with a drum rotation speed of 37.5 rpm (L5).

FIG. 11B shows electron micrographs of a C103 oversized powder oxidized at 400° C. for 1 h after a preclean cycle (Ar+H₂) for 15 minutes, and etching (Ar 5 sccm+SF₆ 5 sccm) for 30 minutes with a drum rotation speed of 3.6 rpm (L2).

FIG. 12 shows a graph (right) of oxygen:metal ratio (O:Nb+Hf) and fluorine:metal ratio (F:Nb+Hf) of samples taken from various locations within the processing chamber (left), after a C103 oversized powder oxidized at 400° C. for 1 h after a preclean cycle and etching (Ar 5 sccm+SF₆ 5 sccm) for 180 minutes with a drum rotation speed of 37.5 rpm (L5).

FIG. 13A shows a graph of oxygen concentration versus etch recipe at a total flow rate of 10 sccm on C103 powder.

FIG. 13B shows a graph of oxygen concentration versus etch recipe at a total flow rate of 4 sccm on C103 powder.

FIG. 14 shows quantitative oxygen analysis of plasma-etched C103 powders with different etch recipes and etch times (based on ON analysis). The top figure shows the oxygen concentration (ppm) for the different recipes and times). The bottom figure shows the recipe number and conditions.

FIG. 15A shows a graph of oxygen concentration versus etch recipe at a total flow rate of 10 sccm on pre-oxidized C103 powder.

FIG. 15B shows a graph of oxygen concentration versus etch recipe at a total flow rate of 4 sccm on pre-oxidized C103 powder.

FIG. 15C shows a graph of oxygen concentration versus SF₆ concentration. At higher total flow (10 sccm)/pressure the gas residence time is shorter. Ar usually helps an SF₆ discharge, and high SF₆ fractions tend to lower the electron density-giving oxygen rebound. At lower total flow (4 sccm)/pressure the longer gas residence time favors complete reaction and removal, so the performance keeps improving up to 100% SF₆.

FIG. 16A shows an electron micrograph and parameters for etching a C103 powder that was oxidized at 400° C. for 1 h.

FIG. 16B shows a graph of oxygen:metal ratio (O:Nb+Hf) versus the etch recipe from FIG. 11A.

FIG. 16C shows a graph of fluorine:metal ratio (F:Nb+Hf) versus the etch recipe from FIG. 11A.

FIG. 17 shows a schematic diagram of the active learning workflow used to optimize etching parameters.

### DETAILED DESCRIPTION

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended clauses.

For the sake of brevity, the disclosures of the publications cited in this specification, including patents, are herein incorporated by reference. Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

As used herein and in the appended clauses, the singular forms “a,” “an,” and “the” include plural referents unless the context clearly dictates otherwise. It is further noted that the clauses may be drafted to exclude any optional element. As such, this statement is intended to serve as antecedent basis for use of such exclusive terminology as “solely,” “only” and the like in connection with the recitation of clause elements, or use of a “negative” limitation.

As used herein, the terms “including,” “containing,” and “comprising” are used in their open, non-limiting sense.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

Except as otherwise noted, the methods and techniques of the present embodiments are generally performed according to conventional methods well known in the art and as described in various general and more specific references that are cited and discussed throughout the present specification. Sec, e.g., Loudon, Organic Chemistry, Fourth Edition, New York: Oxford University Press, 2002, pp. 360-361, 1084-1085; Smith and March, March's Advanced Organic Chemistry: Reactions, Mechanisms, and Structure, Fifth Edition, Wiley-Interscience, 2001.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination.

Unless otherwise defined herein, scientific and technical terms used in this application shall have the meanings that are commonly understood by those of ordinary skill in the art. Generally, nomenclature used in connection with, and techniques of chemistry, analytical chemistry, physical chemistry, materials chemistry, engineering, chemical engineering, and materials engineering described herein, are those well known and commonly used in the art.

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “downstream” and “upstream” may be used herein to refer to a relative location with respect to the flow of a sample through a system. For example, in a system where component A is coupled to component B, and a sample flows through component A then component B, it will be understood that component A is located/disposed upstream of component B, and component B is located/disposed downstream of component A.

As used herein, the term “Global Warming Potential (GWP)” refers to a metric that measures a greenhouse gas's heat-trapping ability relative to carbon dioxide (CO₂) over a specific timeframe, most commonly 100 years (GWP100). GWP is calculated by the IPCC and expressed as carbon dioxide equivalents (CO2e).

The system and method of the present disclosure includes a dry-etch plasma to remove oxidized material from a refractory metal alloy powder, such as a Nb-based alloy C103 powder, for reuse in AM processes. The present disclosure may be suitable for other Nb/Hf alloys and powders including Ti or Al. Both High Global Warming Potential (GWP) and Low GWP processing gases may be used to efficiently remove oxidized material. In an exemplary embodiment, the surface oxide layer (e.g., oxidized material) was removed from a C103 substrate within ten minutes using the system and method of the present disclosure.

An object of the present disclosure is to develop a cost-effective, safe, and environmentally friendly plasma etch powder reconditioning system and method that removes surface oxidation/oxides (e.g., oxidized material) from a variety of powder substrates, such as refractory additive manufacturing (AM) powder. This process can be used to recycle and recondition refractory AM powder, and also pre-treat waste streams for other recycling or reclaiming processes. The combination of successful recycling and an environmentally friendly reconditioning process will enable cost and energy savings and significant reductions in workplace hazards by eliminating contact with hydrofluoric acid and other caustic wet etch solutions.

Another object of the present disclosure is to identify the appropriate processing conditions (e.g., gas, pressure, and powder handling conditions) to recondition the powder and remove deleterious products such as oxides and oxygen-rich layers (e.g., oxidized material) on the powder surface.

The method and system of the present disclosure may address one or more challenges associated with etching of powder substrates. For example, the system of the present disclosure may exclude ion bombardment. Additionally, irregular packing and shape of powders can cause micro-shadowing, where reactive species (e.g., ions or radicals) fail to reach inner surfaces. The gas access to deep voids is diffusion-limited, therefore the rate-limiting step is often gas-phase transport instead of surface chemistry. Powders on floating surfaces can accumulate charge that may lease to non-uniform electric fields and unpredictable etching behavior. Residue formation, such as non-volatile fluorides may halt further etching and contaminate powder surface.

In some embodiments, the present disclosure provides a method of removing an oxidized material from an oxidized substrate comprising a base material and the oxidized material. For example, the method of the present disclosure provides a method to remove an oxidized layer from a substrate and reduce the overall oxygen content. In some embodiments, the method comprises etching the oxidized substrate to provide an etched substrate.

In some embodiments, the method comprises:
generating a plasma from a processing gas; and
contacting the oxidized substrate with the plasma, thereby removing the oxidized material from the oxidized substrate to provide an etched substrate.

In some embodiments, the oxidized substrate (e.g., the oxidized material) comprises an oxide formed from a transition metal or an alloy thereof. The oxidized substrate may include an outer layer (e.g., an exposed outer layer) comprising the oxidized material. For example, the outer layer may be disposed on an inner layer comprising a base material.

In some embodiments, the oxidized substrate (e.g., the base material) comprises a transition metal or an alloy thereof, such as a refractory metal or an alloy thereof. In some embodiments, the transition metal or an alloy thereof comprises a transition metal selected from iridium, osmium, niobium, molybdenum, tantalum, tungsten, rhenium, rhodium, ruthenium, hafnium, titanium, vanadium, zirconium, chromium, or any combination thereof. In some embodiments, the transition metal or an alloy thereof comprises a refractory metal selected from niobium, molybdenum, tantalum, tungsten, rhenium, or any combination thereof. In some embodiments, the transition metal or an alloy thereof comprises niobium, hafnium, titanium, or any combination thereof. In some embodiments, the transition metal or an alloy thereof comprises a niobium alloy. Preferably, the transition metal or an alloy thereof may be a C-103 refractory alloy (89Nb-10Hf-1Ti, wt %).

In some embodiments, the oxidized substrate is a bulk substrate (e.g., a coupon or a sheet) or a powder substrate. In certain preferred embodiments, the oxidized substrate is a powder substrate. The powder substrate, for example, may be a powder (recycled) from a high temperature process, such as a Laser Powder Bed Fusion (LPBF) process. In some embodiments, the powder substrate has an average diameter of about 25 microns to about 200 microns.

In some embodiments, the oxidized substrate has a mass of about 0.1 g to about 1 kg. For example, the oxidized substrate has a mass of about 1 g to about 25 g.

In some embodiments, the oxidized substrate is disposed on a stage configured to hold the oxidized substrate, such as during a plasma etching process. The stage may be arranged within and coupled to a processing chamber. In some embodiments, the stage is a stationary planar surface (e.g., an electrode) or a rotatable drum. The stage may be grounded. In some embodiments, the rotatable drum is cylindrical, comprising a sidewall and two endcaps. The rotatable drum may be gas/plasma permeable. For example, the rotatable drum may comprise a perforated surface (e.g., sidewall or endcap), thereby allowing for gas/plasma to diffuse within the rotatable drum and/or contact the oxidized substrate.

In some embodiments, the method comprises a step of providing an oxidized substrate. The oxidized substrate may be provided by an oxidation process (e.g., a thermal oxidation process). For example, a substrate (e.g., a base material) may be exposed to oxygen/air at high temperatures (e.g., during an LPBF treatment), thereby oxidizing the substrate and forming an oxidized material from the base material. In some embodiments, the substrate comprises a transition metal or an alloy thereof. For example, the transition metal or an alloy thereof of the substrate may be arranged on an outer surface (e.g., an exposed outer surface) of the substrate. In some embodiments, the oxidized substrate includes the oxidized material disposed on the base material.

In some embodiments, the step of oxidizing the substrate includes heating the substrate to a temperature of greater than about 300° C., such as about 400° C. In some embodiments, the step of oxidizing the substrate includes heating the substrate for about 1 hr to about 5 hrs.

In some embodiments, the oxidized material comprises an oxide formed from a transition metal or an alloy thereof. For example, the oxidized material may comprise an oxide formed from a refractory metal or an alloy thereof. In some embodiments, the oxidized material comprises an oxide comprising niobium (e.g., Nb₂O₅), hafnium (e.g., HfO₂), or a combination thereof.

In some embodiments, the method includes a step of generating a plasma from a processing gas. In some embodiments, the processing gas comprises a reactive gas, such as a fluorine gas (e.g., SF₆, or a fluorocarbon, such as CF₄ (R-14), CHF₃ (HFC-23), CH₃F (R-41), CH₂FCF₂CHF₂ (HFC-245ca), CF₃CH₂CF₂CH₃ (HFC-365mfc), CF₃CH₃ (HFC-143a), CHF₂CF₃ (HFC-125), CH₂CFCF₃ (HFO-1234yf), CH₂FCF₃ (HFC-134a), C₂H₄F₂ (HFC-152a), CCl₂F₂ (CFC-12), or a combination thereof). The fluorine gas, for example, may include CF₂CH₂CF₂CH₃ (HFC-365mfc), CH₂CFCF₃ (HFO-1234yf), CH₃FCF₃ (HFC-134a), or any combination thereof. In some embodiments, the processing gas comprises SF₆, CF₄ (R-14), CHF₃, or any combination thereof. The reactive gas may also include other halogenated gases, such as chlorine. In some embodiments, the processing gas comprises a non-reactive gas (e.g., H₂, Ar, He, N₂, or a combination thereof). In some embodiments, the processing gas is a mixture of a fluorine gas and a non-reactive gas. The mixture, for example, may include SF₆, CF₄ (R-14), CHF₃, H₂, Ar, or any combination thereof. In some embodiments, the processing gas comprises SF₆, a mixture of SF₆ and Ar, or a mixture of SF₆, Ar, and H₂. In some embodiments, the processing gas comprises CF₄, a mixture of CF₄ and Ar, or a mixture of CF₄, Ar, and H₂.

In some embodiments, the processing gas has a Global Warming Potential (GWP) (i.e., relative to CO₂) of less than about 20,000 (e.g., about 0 to about 20,000). For example, the processing gas may have a GWP of less than about 10,000, less than about 1,000, or less than about 700.

In some embodiments, the step of generating a plasma comprises: providing the processing gas to a processing chamber, and applying a radiofrequency (RF) (e.g., about 40 kHz, about 80 kHz, about 13.56 MHz, or about 2.46 GHZ) power to an electrode and/or an inductive coil coupled to the processing chamber, thereby generating an electric field and forming the plasma.

In some embodiments, the step of generating a plasma comprises: providing the processing gas to a processing chamber, and generating a plasma from the process gas by an inductively coupled plasma (ICP) generation process or by a capacitively coupled plasma (CCP) generation process. Each of an inductively coupled plasma (ICP) generation process and a capacitively coupled plasma (CCP) generation process, may include applying a radiofrequency (RF) (e.g., about 40 kHz, about 80 kHz, about 13.56 MHz, or about 2.46 GHZ) power to an electrode and/or an inductive coil coupled to the processing chamber, thereby generating an electric field and forming the plasma.

In some embodiments, the processing gas is provided to a processing chamber, such as through a gas inlet coupled to the processing chamber and a processing gas source.

In some embodiments, the radiofrequency (RF) (e.g., about 40 kHz, about 80 kHz, about 13.56 MHz, or about 2.46 GHz) power is independently applied to an electrode and/or an inductive coil coupled to the processing chamber. For example, the RF power is applied to an electrode in a capacitively coupled plasma (CCP) generation process, and the RF power is applied to an inductive coil and/or an electrode in an inductively coupled plasma (ICP) generation process. In some embodiments, the step of generating the plasma is an inductively coupled plasma (ICP) generation process or a capacitively coupled plasma (CCP) generation process. In some embodiments, the RF power applied to an electrode generates an electric field. In some embodiments, the RF power applied to an inductive coil generates an electric field, such as an electromagnetic field (e.g., a time-varying magnetic field). In an inductively coupled plasma (ICP) generation process, the RF power is applied to an inductive coil (also referred to as source power) and/or an electrode (also referred to as substrate bias power or voltage).

In some embodiments, the processing gas is provided to the processing chamber (through a gas inlet) at a total flow rate of about 1 sccm to about 100 sccm. For example, the processing gas may be provided to the processing chamber at a total flow rate of about 10 sccm to about 50 sccm.

In some embodiments, the processing chamber has a total volume of about 10 L to about 100 L. For example, the processing chamber may have a total volume of about 25 L to about 50 L or about 30 L to about 40 L, such as about 35 L.

In some embodiments, the processing gas is provided to the processing chamber at a total flow rate per volume of the processing chamber of about 0.01 sccm/L to about 10 sccm/L. For example, the processing gas may be provided to the processing chamber at a total flow of about 0.02 sccm/L to about 4 sccm/L or about 0.04 sccm/L to about 2 sccm/L).

In some embodiments, the processing gas is provided to the processing chamber having a ratio of a reactive gas to a non-reactive gas of about 10:0 (e.g., 100% reactive gas) to about 0:10 (e.g., 100% non-reactive gas). For example, the processing gas may be provided to the processing chamber having a ratio of a reactive gas to a non-reactive gas of about 4:0 to about 1:4.

In some embodiments, the process gas comprises a mixture of Ar, CF₄, and H₂ present at a ratio (e.g., of mass flow (sccm)) of about 4:33:31, about 47:15:50, about 14:44:0.0, about 4:17:38, about 50:26:2, about 24:45:16, 3 about 7:8:27, about 21:30:13, about 41:8:38, or about 30:39:47. In some embodiments, the process gas comprises a mixture of Ar, CF₄, and H₂ present at a ratio (e.g., of flow mass flow (sccm)) of about 24:39:7, about 3:50:0, about 50:2:50, about 3:50:50, about 0:13:37, about 38:50:0, or about 50:0:12. In some embodiments, the process gas comprises a mixture of Ar, CF₄, and H₂ present at a ratio (e.g., of flow mass flow (sccm)) of about 10:10:0. In some embodiments, the process gas comprises a mixture of Ar, SF₆, and H₂ present at a ratio (e.g., of flow mass flow (sccm)) of about 5:0:5, about 15:3:9, about 0:4:0, or about 1:4:0.

In some embodiments, the applied RF power (e.g., source power) is less than or equal to about 800 W (e.g., about 100 W to about 300 W).

In some embodiments, the applied RF power (e.g., substrate bias power/voltage) is less than or equal to about 300 W (e.g., about 10 W to about 100 W).

In some embodiments, the method includes a step of contacting the oxidized substrate (e.g., oxidized material) with the plasma (e.g., a plasma generated from a processing gas comprising a reactive gas, such as a fluorine gas), thereby removing the oxidized material from the oxidized substrate to provide an etched substrate.

In some embodiments, the step of contacting the oxidized substrate with the plasma includes contacting the oxidized substrate with a (pre-cleaning) plasma generated from a processing gas comprising a non-reactive gas, prior to contacting the oxidized substrate with a plasma generated from a processing gas comprising a reactive gas, such as a fluorine gas. In some embodiments, the pre-cleaning plasma is generated by a processing gas excludes a reactive gas, such as a fluorine gas. In some embodiments, the pre-cleaning plasma is generated by a processing gas comprising a non-reactive gas (e.g., H₂, Ar, He, N₂, or a combination thereof). For example, the pre-cleaning plasma is generated by a processing gas comprising a H₂, Ar, or a mixture thereof.

In some embodiments, the oxidized substrate is in contact with the pre-cleaning plasma for about 1 second to about 300 minutes. The oxidized substrate, for example, may be in contact with the pre-cleaning plasma for about 1 minute to about 100 minutes or about 5 minutes to about 30 minutes.

In some embodiments, the step of contacting the oxidized substrate with the plasma comprises rotating the rotatable drum at a speed of about 0 rpm to about 100 rpm. For example, the rotatable drum may rotate at a speed of about 0 rpm to about 85 rpm. In some embodiments, the rotatable drum does not rotate (0 rpm), or the rotatable drum rotates at a speed of about 0.1 rpm to about 100 rpm.

In some embodiments, the step of contacting the oxidized substrate with the plasma is performed at a pressure (within the processing chamber) of about 1 mTorr to about 500 mTorr (e.g., about 5 mTorr to about 300 mTorr).

In some embodiments, the oxidized substrate is in contact with the plasma for about 1 second to about 300 minutes. The oxidized substrate, for example, may be in contact with the plasma for about 1 minute to about 100 minutes or about 5 minutes to about 30 minutes. The contact time of the oxidized substrate may be the same as the residence time of the oxidized substrate within the processing chamber.

In some embodiments, the step of contacting the oxidized substrate with the plasma is performed continuously or cyclically.

In some embodiments, the step of contacting the oxidized substrate with the plasma is performed simultaneously with the step of generating the plasma. For example, plasma may be generated at the same time plasma is contacting the oxidized substrate.

In some embodiments, the oxidized material is removed from the oxidized substrate in an isotropic direction (e.g., isotropic etching) or an anisotropic direction (e.g., anisotropic etching). Etching direction may be dependent on reactor operating conditions (e.g., plasma generation process, processing gas composition, and processing chamber conditions). For example, in both CCP and ICP reactors, etch profiles are controlled by substrate bias, pressure, and gas chemistry. Substrate bias at low pressure enhances ion bombardment, favoring anisotropic etching. In contrast, zero/low bias at higher pressure promotes isotropic etching due to scattering and diffusion. Fluorine-rich plasmas (e.g., SF₆, CF₄) generally drive isotropic, chemically dominated etching unless balanced by ion bombardment or sidewall passivation. Adding Ar, or increasing bias, enhances the sputtering component and reinforces anisotropy.

In some embodiments, the oxidized material is removed from the oxidized substrate at an etch rate of about 0.5 μm/min to about 2.0 μm/min. Etch rate, for example, may be measured using an optical profilometer.

In some embodiments, the oxidized substrate has an oxygen content prior to the step of contacting the oxidized substrate, and the oxidized substrate has an oxygen content after the step of contacting the oxidized substrate. The oxygen content may be determined from measuring the elemental content of the oxidized substrate, such as using XPS, EDS, and/or ON analysis techniques. EDS, for example, may be used to determine elemental composition (Nb, Hf, O, F), and ON analysis may be used to determine oxygen content (ppm) and oxygen removal rates.

In some embodiments, the step of contacting the oxidized substrate reduces the oxygen content of the oxidized substrate. The reduction of the oxygen content of the oxidized substrate may correspond to the amount of oxidized material removed from the oxidized substrate. For example, the step of contacting the oxidized substrate reduces the oxygen content of the oxidized substrate by about 20% to about 100%. In some embodiments, the step of contacting the oxidized substrate removes about 20% to about 100% of the oxidized material from of the oxidized substrate.

In some embodiments, the oxidized substrate has an atomic (mole) ratio of oxygen to the transition metal or an alloy thereof prior to the step of contacting the oxidized substrate, and the oxidized substrate has an atomic (mole) ratio of oxygen to the transition metal or an alloy thereof after the step of contacting the oxidized substrate. The atomic ratio may be determined from measuring the elemental content of the oxidized substrate, such as using XPS, EDS, and/or ON analysis techniques.

In some embodiments, the step of contacting the oxidized substrate with the plasma reduces the atomic (mole) ratio of oxygen to the transition metal or an alloy thereof.

In some embodiments, the method comprises a step of measuring an elemental content (e.g., oxygen, fluorine, or metal) of the oxidized substrate and/or etched substrate using an elemental analyzer (e.g., an X-Ray photoelectron spectrometer (XPS), an energy-dispersive X-ray spectrometer (EDS), and/or an oxygen/nitrogen (ON) analyzer). An elemental ratio, an oxygen concentration, and/or an oxygen removal rate can be determined based on the elemental content measurement.

In some embodiments, the etched substrate is substantially free of the oxidized material. For example, the etched substrate may be substantially free of a transition metal-oxide bond.

In some embodiments, the etched substrate comprises a fluoride material (e.g., an amorphous metal-fluoride material) disposed on the base material. For example, the fluoride material may be generated by contacting (e.g., fluorinating) the base material with the plasma.

In some embodiments, the method comprises a step of contacting the etched substrate with a finishing plasma (e.g., plasma generated from a non-reactive processing gas). In some embodiments, the step of contacting the etched substrate with a finishing plasma includes removing a fluoride material from the etched substrate.

In some embodiments, the method comprises a step of cooling the etched substrate in an inert environment, thereby reducing (re) oxidation of the etched substrate. The inert environment, for example, may include a non-reactive gas, such as H₂, Ar, He, N₂, or a combination thereof.

In some embodiments, the etched substrate consists essentially of the base material (e.g., transition metal or an alloy thereof) after contacting the finishing plasma.

In some embodiments, the etched substrate is used (re-used) in a high temperature process, such as a Laser Powder Bed Fusion (LPBF) process.

In some embodiments, the method comprises a step of predicting an etching parameter using an active learning method (e.g., machine learning method) based on a measured property (e.g., elemental content) of the oxidized substrate, the etched substrate, or a combination thereof. The active learning method, for example, may be used to predict an etching parameter to optimize the measured property (e.g., minimize oxygen content and/or fluorine content) of the etched substrate provided by the method of the present disclosure. The active learning method, for example, may implement a computational algorithm (e.g., Bayesian optimization) using a measured property (e.g., elemental content) to predict the etching parameter.

In some embodiments, the etching parameter is selected from a mass of the oxidized substrate, a residence time of the oxidized substrate in the processing chamber, a pressure of the processing chamber, a composition of the processing gas, a total flow rate of the processing gas, an RF power of an RF power supply, a drum speed of a rotatable drum, or any combination thereof.

In some embodiments, the method comprises performing (e.g., repeating) one or more steps of the method using the predicted etching parameter.

In some embodiments, the method provides for a semi-selective removal of the oxidized material from the oxidized substrate.

In some embodiments, the present disclosure provides a system for removing an oxidized material from an oxidized substrate comprising a base material and the oxidized material.

In some embodiments, the system comprises a processing chamber configured to provide an etched substrate from the oxidized substrate, a gas inlet configured to supply a processing gas into the processing chamber, a radiofrequency (RF) power supply configured to supply radio-frequency power to an electrode and/or an inductive coil for generating a plasma from the processing gas, and a stage configured to hold the oxidized substrate.

In some embodiments, each of the gas inlet, the RF power supply, the electrode and/or the inductive coil, and the stage is independently coupled to the processing chamber. In some embodiments, the RF power supply is coupled to the electrode and/or the inductive coil. In some embodiments, the gas inlet is coupled to a processing gas source.

In some embodiments, the oxidized substrate comprises an oxide formed from a transition metal or an alloy thereof. The oxidized substrate may include an outer layer (e.g., an exposed outer layer) comprising an oxidized material. For example, the outer layer may be disposed on an inner layer comprising a base material.

In some embodiments, the oxidized substrate comprises a transition metal or an alloy thereof. In some embodiments, the transition metal or an alloy thereof comprises a transition metal selected from iridium, osmium, niobium, molybdenum, tantalum, tungsten, rhenium, rhodium, ruthenium, hafnium, titanium, vanadium, zirconium, chromium, or any combination thereof. In some embodiments, the transition metal or an alloy thereof comprises a refractory metal selected from niobium, molybdenum, tantalum, tungsten, rhenium, or any combination thereof. In some embodiments, the transition metal or an alloy thereof comprises niobium, hafnium, titanium, or any combination thereof. In some embodiments, the transition metal or an alloy thereof comprises a niobium alloy. Preferably, the transition metal or an alloy thereof may be a C-103 refractory alloy (89Nb-10Hf-1Ti, wt %).

In some embodiments, the oxidized substrate is a bulk substrate (e.g., a coupon or a sheet) or a powder substrate. In certain preferred embodiments, the oxidized substrate is a powder substrate. The powder substrate, for example, may be a powder from a high temperature process, such as a Laser Powder Bed Fusion (LPBF) process. In some embodiments, the powder substrate has an average diameter of about 25 microns to about 200 microns.

In some embodiments, the oxidized substrate has a mass of about 0.1 g to about 1 kg. For example, the oxidized substrate has a mass of about 1 g to about 25 g. The stage may be arranged within and coupled to a processing chamber. In some embodiments, the stage is a stationary planar surface (e.g., an electrode) or a rotatable drum. The stage may be grounded. In some embodiments, the rotatable drum is cylindrical, comprising a sidewall and two endcaps. The rotatable drum may be gas/plasma permeable. For example, the rotatable drum may comprise a perforated surface (e.g., sidewall or endcap), thereby allowing for gas/plasma to diffuse within the rotatable drum and/or contact the oxidized substrate.

In some embodiments, the rotatable drum is arranged so that the sidewall of the rotatable drum is about 1 cm to about 20 cm from the surface of the electrode. For example, the rotatable drum may be arranged so that the sidewall of the rotatable drum is about 2 cm to about 6 cm, such as about 5.5 cm, from the surface of the electrode.

In some embodiments, the rotatable drum has an outer diameter, an inner diameter, and a sidewall length. For example, the inner diameter of the rotatable drum may be about 1 cm to about 10 cm, the inner diameter of the rotatable drum may be about 2 cm to about 15 cm, and the sidewall length of the rotatable drum may be about 5 cm to about 25 cm, such as about 15 cm.

In some embodiments, the rotatable drum comprises aluminum or an alloy thereof, such as 6061 Al.

In some embodiments, the processing gas comprises a reactive gas, such as a fluorine gas (e.g., SF₆, or a fluorocarbon, such as CF₄ (R-14), CHF₃ (HFC-23), CH₃F (R-41), CH₂FCF₂CHF₂ (HFC-245ca), CF₃CH₂CF₂CH₃ (HFC-365mfc), CF₃CH₃ (HFC-143a), CHF₂CF₃ (HFC-125), CH₂CFCF₃ (HFO-1234yf), CH₂FCF₃ (HFC-134a), C2H₄F₂ (HFC-152a), CCl₂F₂ (CFC-12), or a combination thereof). The fluorine gas, for example, may include CF₂CH₂CF₂CH₃ (HFC-365mfc), CH₂CFCF₃ (HFO-1234yf), CH₃FCF₃ (HFC-134a), or any combination thereof. In some embodiments, the processing gas comprises SF₆, CF₄ (R-14), CHF₃, or any combination thereof. The reactive gas may also include other halogenated gases, such as chlorine. In some embodiments, the processing gas comprises a non-reactive gas (e.g., H₂, Ar, He, N₂, or a combination thereof). In some embodiments, the processing gas is a mixture of a fluorine gas and a non-reactive gas. The mixture, for example, may include SF₆, CF₄ (R-14), CHF₃, H₂, Ar, or any combination thereof. In some embodiments, the processing gas comprises SF₆, a mixture of SF₆ and Ar, or a mixture of SF₆, Ar, and H₂. In some embodiments, the processing gas comprises CF₄, a mixture of CF₄ and Ar, or a mixture of CF₄, Ar, and H₂.

In some embodiments, the processing gas has a Global Warming Potential (GWP) (i.e., relative to CO₂) of less than about 20,000 (e.g., about 0 to about 20,000). For example, the processing gas may have a GWP of less than about 10,000, less than about 1,000, or less than about 700.

In some embodiments, the processing gas is provided to the processing chamber (through a gas inlet) at a total flow rate of about 1 sccm to about 100 sccm. For example, the processing gas may be provided to the processing chamber at a total flow rate of about 10 sccm to about 50 sccm.

In some embodiments, the processing chamber has a total volume of about 10 L to about 100 L. For example, the processing chamber may have a total volume of about 25 L to about 50 L or about 30 L to about 40 L, such as about 35 L.

In some embodiments, the processing gas is provided to the processing chamber at a total flow rate per volume of the processing chamber of about 0.01 sccm/L to about 10 sccm/L. For example, the processing gas may be provided to the processing chamber at a total flow of about 0.02 sccm/L to about 4 sccm/L or about 0.04 sccm/L to about 2 sccm/L).

In some embodiments, the processing chamber has a pressure of about 1 mTorr to about 500 mTorr (e.g., about 5 mTorr to about 300 mTorr).

In some embodiments, the system is configured to remove the oxidized material from the oxidized substrate at an etch rate of about 0.5 μm/min to about 2.0 μm/min. Etch rate, for example, may be measured using an optical profilometer.

In some embodiments, the system comprises a vacuum inlet and a processing chamber vent, each coupled to the processing chamber and configured to modulate pressure within the processing chamber.

In some embodiments, the system comprises any number of meters or gauges coupled to the processing chamber configured to determine/measure a particular parameter within the chamber (e.g., pressure/vacuum, temperature, gas flow speed, drum speed, etc.). For example, the system may include a gauge, such as a Pirani gauge, configured to measure vacuum.

### ALTERNATIVE EMBODIMENTS

1. A method of removing an oxidized material from an oxidized substrate comprising a base material and the oxidized material, the method comprising:
generating a plasma from a processing gas; and
contacting the oxidized substrate with the plasma, thereby removing the oxidized material from the oxidized substrate to provide an etched substrate,
wherein the oxidized substrate comprises a transition metal or an alloy thereof.

2. The method of clause 1, wherein the transition metal or an alloy thereof comprises iridium, osmium, niobium, molybdenum, tantalum, tungsten, rhenium, rhodium, ruthenium, hafnium, titanium, vanadium, zirconium, chromium, or any combination thereof, preferably wherein the transition metal or alloy comprises niobium, molybdenum, tantalum, tungsten, rhenium, or any combination thereof.

3. The method of clause 1 or clause 2, wherein the transition metal or an alloy thereof comprises niobium, hafnium, titanium, or any combination thereof (e.g., niobium, hafnium, and titanium, such as C103 alloy).

4. The method of any one of the preceding clauses, wherein the oxidized substrate is a bulk substrate (e.g., a coupon or a sheet) or a powder substrate.

5. The method of any one of the preceding clauses, wherein the oxidized substrate is disposed on a stage configured to hold the oxidized substrate.

6. The method of any one of the preceding clauses, wherein the stage is a stationary planar surface or a rotatable drum.

7. The method of clause 6, wherein the step of contacting the oxidized substrate with the plasma comprises rotating the rotatable drum at a speed of about 1 rpm to about 100 rpm.

8. The method of any one of the preceding clauses, wherein the processing gas comprises a reactive gas, such as a fluorine gas (e.g., SF₆, or a fluorocarbon, such as CF₄ (R-14), CHF₃ (HFC-23), CH₃F (R-41), CH₂FCF₂CHF₂ (HFC-245ca), CF₃CH₂CF₂CH₃ (HFC-365mfc), CF₃CH₃ (HFC-143a), CHF₂CF₃ (HFC-125), CH₂CFCF₃ (HFO-1234yf), CH₂FCF₃ (HFC-134a), C2H₄F₂ (HFC-152a), CCl₂F₂ (CFC-12)).

9. The method of any one of the preceding clauses, wherein the processing gas comprises a non-reactive gas, such as H₂, Ar, He, N₂, or a combination thereof.

10. The method of any one of the preceding clauses, wherein the processing gas has a Global Warming Potential (GWP) of less than about 20,000 (e.g., about 0 to about 20,000, such as about 0 to about 10,000).

11. The method of any one of the preceding clauses, wherein the step of generating a plasma comprises:
providing the processing gas to a processing chamber, and
applying a radiofrequency (RF) (e.g., about 40 kHz, about 80 kHz, about 13.56 MHz, or about 2.46 GHz) power to an electrode and/or an inductive coil coupled to the processing chamber, thereby generating an electric field and forming the plasma.

12. The method of clause 11, wherein the processing gas is provided to the processing chamber at a total flow rate per volume of the processing chamber of about 0.01 sccm/L to about 10 sccm/L (e.g., about 0.02 sccm/L to about 4 sccm/L).

13. The method of clause 11, wherein the RF power is applied is less than or equal to about 800 W (e.g., about 100 W to about 300 W).

14. The method of any one of the preceding clauses, wherein the step of generating the plasma is an inductively coupled plasma (ICP) generation process or a capacitively coupled plasma (CCP) generation process.

15. The method of any one of the preceding clauses, wherein the step of contacting the oxidized substrate with the plasma is performed at a pressure of about 1 mTorr to about 500 mTorr (e.g., about 5 mTorr to about 300 mTorr).

16. The method of any one of the preceding clauses, wherein the oxidized substrate is in contact with the plasma for about 1 second to about 300 minutes (e.g., about 1 minutes to about 10 minutes).

17. The method of any one of the preceding clauses, wherein the step of contacting the oxidized substrate with the plasma is performed continuously or cyclically.

18. The method of any one of the preceding clauses, wherein the step of contacting the oxidized substrate with the plasma is performed simultaneously with the step of generating the plasma.

19. The method of any one of the preceding clauses, wherein the oxidized material is removed from the oxidized substrate in an isotropic direction (e.g., isotropic etching) or an anisotropic direction (e.g., anisotropic etching).

20. The method of any one of the preceding clauses, wherein the oxidized substrate has an oxygen content prior to the step of contacting the oxidized substrate, and the step of contacting the oxidized substrate reduces the oxygen content of the oxidized substrate (e.g., by about 20% to about 100%).

21. The method of any one of the preceding clauses, wherein the oxidized substrate has an atomic ratio of oxygen to the transition metal or an alloy thereof prior to the step of contacting the oxidized substrate with the plasma, and the step of contacting the oxidized substrate with the plasma reduces the atomic ratio of oxygen to the transition metal or an alloy thereof.

22. The method of any one of the preceding clauses, further comprising a step of measuring an elemental content (e.g., oxygen, fluorine, or metal) of the etched substrate using an elemental analyzer (e.g., an X-Ray photoelectron spectrometer (XPS), an energy-dispersive X-ray spectrometer (EDS), and/or an oxygen/nitrogen (ON) analyzer).

23. The method of any one of the preceding clauses, wherein the etched substrate is substantially free of the oxidized material (e.g., a transition metal-oxide bond).

24 The method of any one of the preceding clauses, wherein the etched substrate comprises a fluoride material (e.g., an amorphous metal-fluoride material) disposed on the base material.

25. The method of any one of the preceding clauses, further comprising a step of contacting the etched substrate with a finishing plasma (e.g., plasma generated from a processing gas comprising H₂, Ar, or any combination thereof).

26. The method of clause 25, wherein the etched substrate consists essentially of the base material (e.g., transition metal or an alloy thereof) after contacting the finishing plasma.

27. The method of any one of the preceding clauses, further comprising a step of oxidizing a substrate comprising the base material, thereby providing the oxidized substrate having the oxidized material disposed on the base material.

28. The method of any one of the preceding clauses, further comprising a step of predicting an etching parameter using an active learning method (e.g., a machine learning method) based on a measured property (e.g., an elemental content of the oxidized substrate and/or the etched substrate).

29. The method of clause 28, further comprising performing one or more steps of the method using the predicted etching parameter.

30. A system for removing an oxidized material from an oxidized substrate comprising a base material and the oxidized material, the system comprising:
a processing chamber configured to provide an etched substrate from the oxidized substrate,
a gas inlet configured to supply a processing gas into the processing chamber,
a radiofrequency (RF) power supply configured to supply radio-frequency power to an electrode and/or an inductive coil for generating a plasma from the processing gas, and
a stage configured to hold the oxidized substrate,
wherein each of the gas inlet, the RF power supply, the electrode, the inductive coil, and the stage is independently coupled to the processing chamber, and
wherein the oxidized substrate comprises a transition metal or an alloy thereof.

31. The system of clause 30, wherein the stage is a stationary planar surface or a rotatable drum.

32. The system of clause 30 or 31, wherein the stage is a rotatable drum.

33. The system of any one of clauses 30-32, wherein the processing gas comprises fluorine (e.g., SF₆, or a fluorocarbon, such as CF₄ (R-14), CHF₃ (HFC-23), CH₃F (R-41), CH₂FCF₂CHF₂ (HFC-245ca), CF₃CH₂CF₂CH₃ (HFC-365mfc), CF₃CH₃ (HFC-143a), CHF₂CF₃ (HFC-125), CH₂CFCF₃ (HFO-1234yf), CH₂FCF₃ (HFC-134a), C2H₄F₂ (HFC-152a), CCl₂F₂ (CFC-12)).

34. The system of any one of clauses 30-33, wherein the processing gas comprises H₂, Ar, or a combination thereof.

35. The system of any one of clauses 30-34, wherein the processing gas has a Global Warming Potential (GWP) of less than about 20,000 (e.g., about 0 to about 20,000, such as about 0 to about 10,000).

36. The system of any one of clauses 30-35, wherein the oxidized substrate is a bulk substrate (e.g., a coupon or a sheet) or a powder substrate.

37. The system of any one of clauses 30-36, wherein the transition metal or an alloy thereof comprises iridium, osmium, niobium, molybdenum, tantalum, tungsten, rhenium, rhodium, ruthenium, hafnium, titanium, vanadium, zirconium, chromium, or any combination thereof, preferably wherein the transition metal or alloy comprises niobium, molybdenum, tantalum, tungsten, rhenium, or any combination thereof.

38. The system of any one of clauses 30-37, wherein the transition metal or an alloy thereof comprises niobium, hafnium, titanium, or any combination thereof (e.g., niobium, hafnium, and titanium, such as C103 alloy).

39. The system of any one of clauses 30-38, wherein the processing chamber has a pressure of about 1 mTorr to about 500 mTorr (e.g., about 5 mTorr to about 300 mTorr).

### EXAMPLES

The following examples serve to illustrate the present disclosure. The examples are not intended to limit the scope of the disclosure in any way.

### Example 1A

Oxide Removal from C103 Bulk Solid Samples

### Materials/Methods: Capacitively Coupled Plasma (CCP) Etching

### 1. Alloy and Sample Preparation

The material used in this study was a commercial C-103 refractory alloy (89Nb-10Hf-1Ti, wt %, procured from Allegheny Technologies Incorporated (ATI)). Bulk coupons were sectioned, mounted, and mechanically polished following ASTM E3. Polishing was conducted sequentially by coarse SiC grinding (180→400 grit), diamond polishing (6→3→1 μm), and a final 0.05 μm colloidal silica suspension, yielding a mirror-finished surface suitable for oxidation and plasma treatment.

### 2. Thermal Oxidation

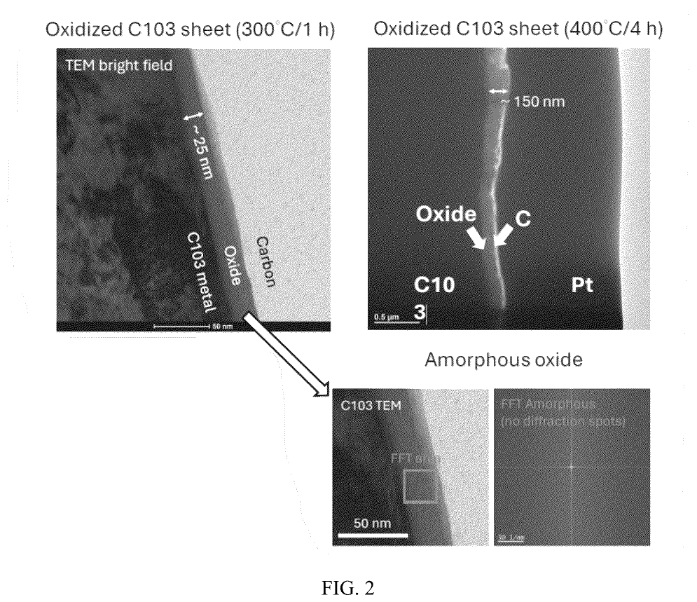

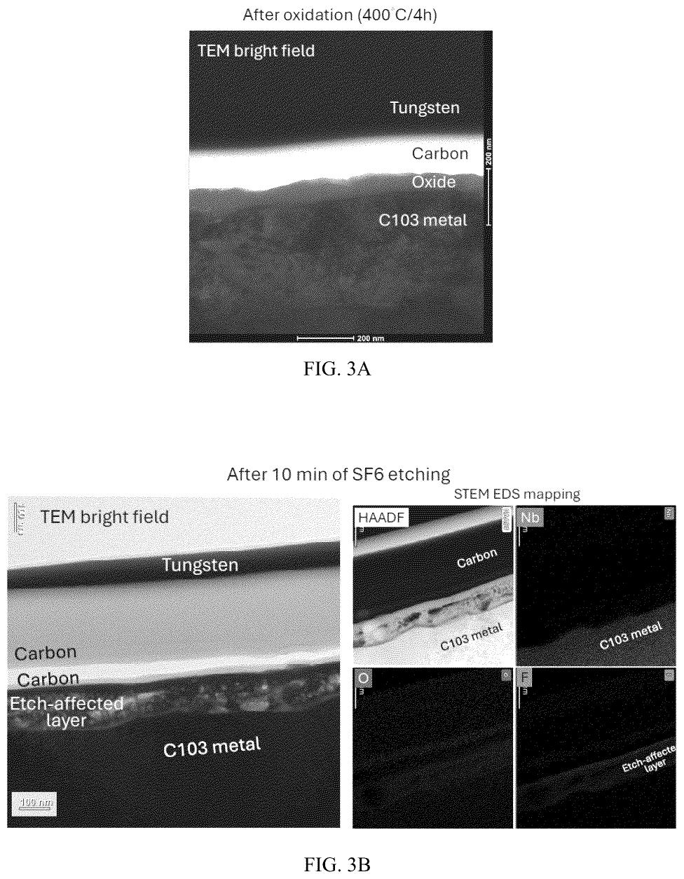

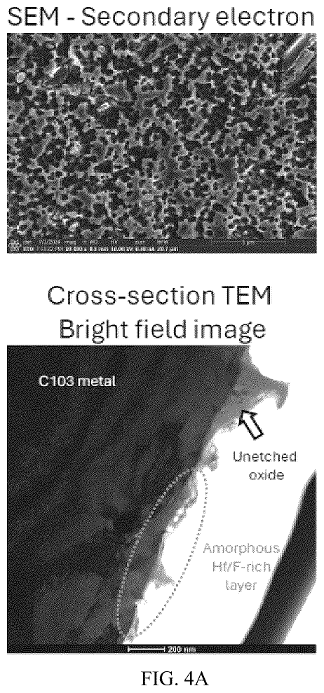

Controlled oxidation was performed in a horizontal tube furnace under flowing air. Samples were oxidized at 300° C. (1 h) and 400° C. (1 h and 4 h), producing progressively thicker Nb₂O₅/HfO₂ scales (FIGS. 2 and 3A). The 400° C./4 h treatment yielded the thickest oxide scale and served as the primary substrate for subsequent plasma etching experiments.

### 3. Photoresist Masking

For selective exposure studies, polished samples were half-coated with AZ15/18 positive photoresist using spin coating (60 s, 1000 rpm), producing a ˜4 μm protective film. The uncoated half was exposed to plasma, enabling post-etch cross-comparison by SEM-EDS and XPS mapping.

### 4. Plasma Etching

Etching was performed in a March Jupiter II capacitively coupled plasma-reactive ion etching (CCP-RIE) system. The chamber is configured for anisotropic etching with an RF power supply operating at 13.56 MHz. Etching was conducted under two gas chemistries:

Pure SF₆: 60 sccm, 200 W RF, chamber pressure measured by Etcher.

SF₆/Ar mixture: 12/48 sccm, 200 W RF, chamber pressure measured by Etcher.

Etching times ranged from 30 s to 1200 s.

### 5. Microstructural and Chemical Characterization

SEM/EDS: Surface morphology and elemental mapping were examined using a Quanta 650 FE-SEM equipped with an EDAX silicon drift detector. Both plan-view and half-masked mapping were employed.

TEM/STEM-EDS: Cross-sectional lamellae were prepared by FIB (FEI Helios) and examined using bright-field TEM and STEM-EDS for oxide thickness and local chemistry.

XPS: Surface chemistry and etch products were analyzed with a Kratos Axis Ultra DLD spectrometer using monochromatic Al Kα radiation. Wide-scan and high-resolution spectra (Nb 3d, Hf 4f, O 1s, F 1s) were acquired with charge neutralization.

### 6. Etch-Rate Measurement

Etch rates were determined by mass loss per unit area using a semi-analytical balance (readability 0.01 mg, repeatability ≤0.02 mg). Each specimen was weighed before (mₒ) and after (mₜ) plasma exposure. The exposed area A was measured optically (stereo microscope with calibrated reticle; uncertainty ≤1%). For masked experiments, only the uncoated window area was used in rate calculations.

### Results:

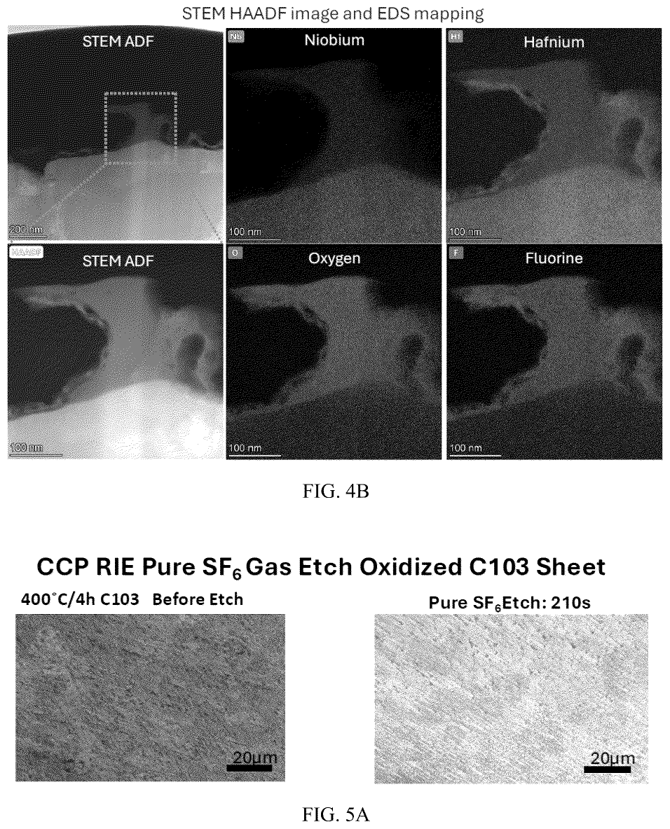

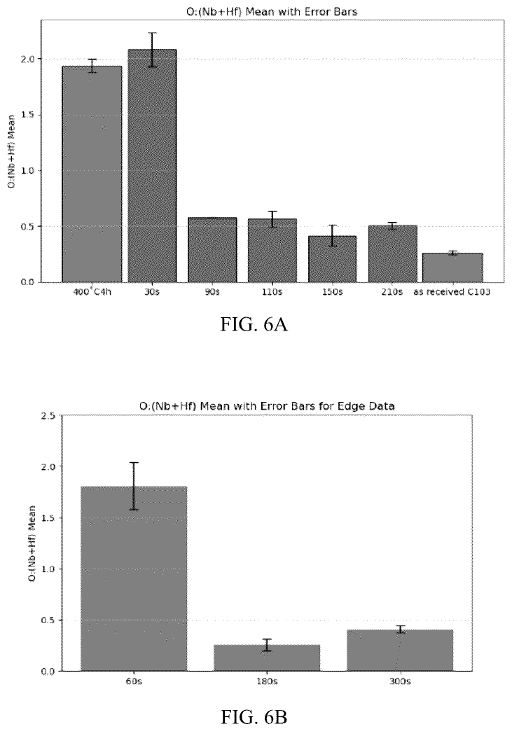

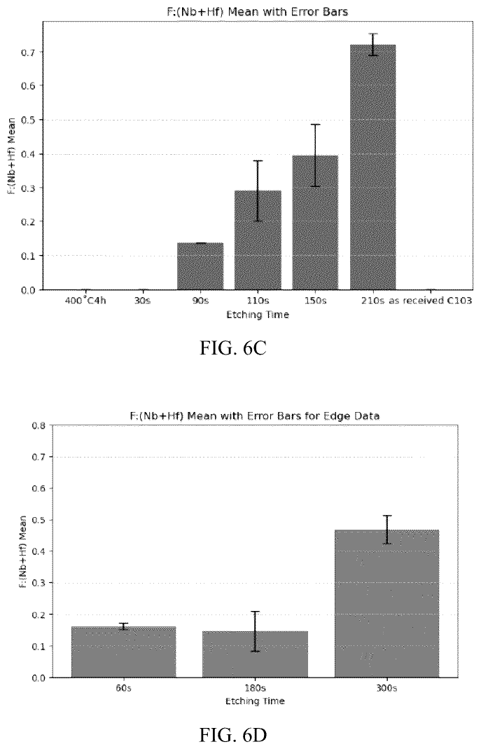

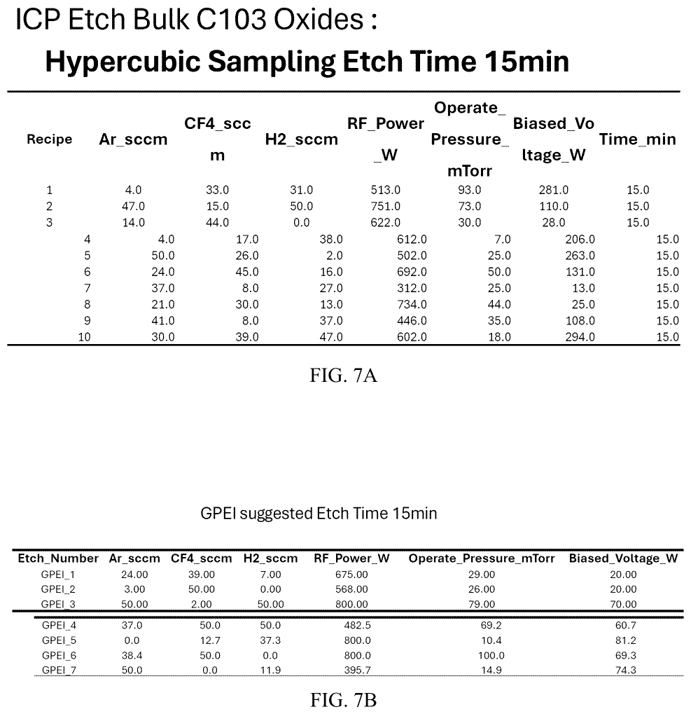

The summarized results of the oxide removal experiments from C103 bulk solid samples (CCP) are shown in FIGS. 3B, 4A, 4B, 5A-5C, 6A-D, 7A-C, 8A-C, and in the Table 1 below.

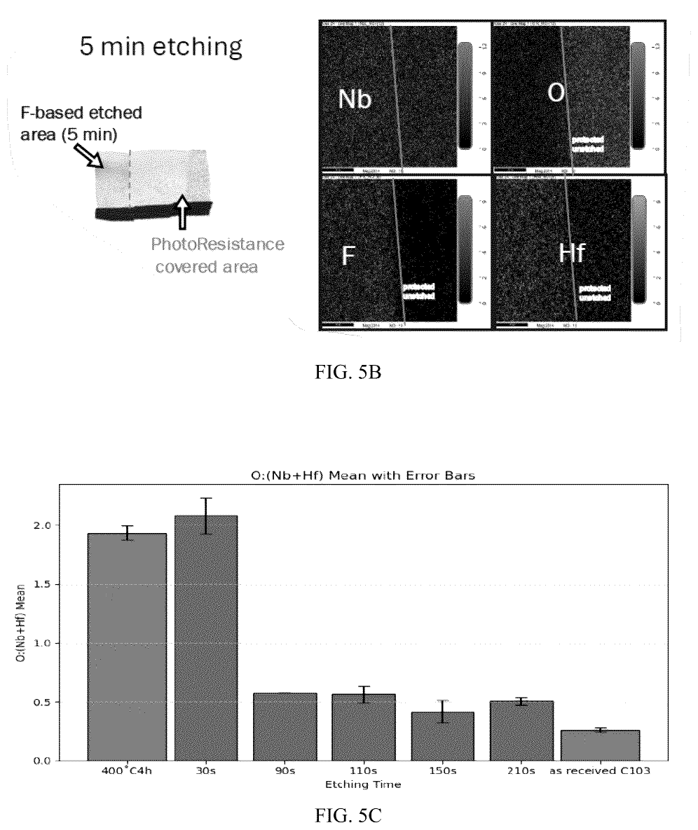

TABLE 1

| Experiment/Parameter | Observation | Conclusion |
|---|---|---|
| Thermal oxidation | Thin, coherent oxide film (TEM). | Time-temperature scaling: |
| (300° C., 1 h) (FIG. 2) | | limited Nb₂O₅/HfO₂ growth. |
| Thermal oxidation | Thick layered Nb₂O₅/HfO₂ (TEM, | Baseline for plasma etching |
| (400° C., 4 h) (FIG. 2) | XPS). | studies. |
| SF₆ plasma, | Plan-view SEM shows nucleation | Nb₂O₅ etched rapidly to |
| 30-210 s | and growth of etch pits → | volatile NbF₅; HfF₄ forms |
| | interconnected pores. O:(Nb + Hf) | residual layer. |
| | drops rapidly; F:(Nb + Hf) | |
| | increases. | |
| SF₆/Ar plasma, | Delayed pit nucleation; smaller, | Ar dilutes F radicals → |
| 30-210 s | anisotropic pores. Slower | slower chemical fluorination. |
| | O:(Nb + Hf) decrease, slower | |
| | F:(Nb + Hf) increase. | |
| STEM cross-sections | Preferential Nb removal; oxide | Selective Nb oxide etching |
| (120-600 s) | thinning; porous Hf/F-rich etch- | vs. HfF₄ passivation. |
| | affected layer. | |
| Half-masked SEM-EDS | Oxygen depleted in etched region; | Confirms oxide → fluoride |
| mapping (FIGS. 5B, 5C) | localized Hf enrichment; strong | conversion, surface |
| | surface F. | passivation. |
| XPS | Native thin Nb₂O₅ + HfO₂ with | Baseline surface chemistry. |
| (as-received) | metallic Nb, Hf visible. | |
| XPS | Nb₂O₅ dominates; metallic Nb | Complete surface oxidation. |
| (oxidized 400° C./4 h) | absent; HfO₂ intensified. | |
| XPS (etched 1-3 min) | Nb₂O₅ → NbO₂ → Nb (no stable | Nb etched via volatile NbF₅; |
| | NbF₅ detected). HfO₂ → HfF₄ | HfF₄ remains involatile. |
| | (>85% by 3 min). | |
| Etch Rate (gravimetric) | SF₆: linear ~0.042 mg cm⁻² min⁻¹. | Ar⁺ sputtering removes |
| | SF₆/Ar: two-stage kinetics (0.009 | passivating HfF₄, |
| | → 0.064). | accelerating etch after |
| | | induction. |

### Example 1B

Oxide Removal from C103 Bulk Solid Samples

### Materials/Methods: Inductively Coupled Plasma (ICP) Etching

Unless otherwise specified, the experiments of the instant example were conducted similarly to the procedures described in Example 1A.

### 1. Plasma Etching

C-103 bulk alloy (Nb-10Hf-1Ti, wt %) samples were etched in an Inductively Coupled Plasma Reactive Ion Etching (ICP-RIE) system. The reactor was operated with an ICP power of 500 W, chamber pressure of 20-50 mTorr, and RF bias of 50 W unless otherwise noted. Typical etch gases included SF₆, CF₄, Cl₂, Ar, and H₂. Gas flow rates were controlled in the range of 2-50 sccm depending on the recipe. Some processes used ternary mixtures (e.g., CF₄+H₂+Ar) to suppress fluoride residue formation.

### 2. Etch Rate Measurements

For bulk C-103 samples etched in the ICP-RIE, the etch depth was quantified by optical profilometry using the step-height method. Selected regions were masked with photoresist prior to etching, and the step depth between etched and unetched areas was measured post-process to calculate etch rate (μm/min). Surface morphology changes were further examined by SEM.

### Results:

The purpose of ICP etching on C103 bulk solids was to investigate oxide removal efficiency and evaluate residue formation mechanisms under different plasma chemistries. Special emphasis was placed on suppressing fluorinated byproducts such as HfF₄ and identifying process windows (e.g., CF₄/H₂/Ar) that yield clean, residue-free surfaces with measurable etch rates. The summarized results of the oxide removal experiments from C103 bulk solid samples (ICP) are shown in Table 2 below.

TABLE 2

| Gas | Sample | | Etch Rate | Residue | |
|---|---|---|---|---|---|
| Chemistry | Condition | Parameters | (μm/min) | Observation | Notes |
| SF₆ | Virgin | 20 sccm SF₆; 500 | 1 | HfF₄ | Etch rate measured by |
| | C103 | W ICP; 50 W bias; | | detected | optical profilometer |
| | | 20-50 mTorr; 15 | | | (step depth) |
| | | min | | | |
| SF₆ | 400° C./4 h | 20 sccm SF₆; 500 | 1 | HfF₄ | Profilometry confirms |
| | oxide | W ICP; 50 W bias; | | detected | F residue despite |
| | | 20-50 mTorr; 15 | | | oxide removal |
| | | min | | | |
| CF₄ | 400° C./4 h | 20 sccm CF₄; 500 | 1.2 | Residual F | Profilometry shows |
| | oxide | W ICP; 50 W bias; | | observed | partial oxide removal; |
| | | 20-50 mTorr; 15 | | | F still present |
| | | min | | | |
| Cl₂ | 400° C./4 h | 20 sccm Cl₂; 500 | 1.1 | No F | Clean surface |
| | oxide | W ICP; 50 W bias; | | residues | confirmed by |
| | | 20-50 mTorr; 15 | | | XPS/EDS; rate by |
| | | min | | | profilometry |
| CF₄ + H₂ + | Virgin | CF₄ (10 sccm) + | 1.17 | No F | Clean surface; etch |
| Ar | C103 | H₂ (8 sccm) + Ar | | residues | rate by optical |
| | | (2 sccm); 500 W | | | profilometer |
| | | ICP; 50 W bias; | | | |
| | | 20-50 mTorr; 15 | | | |
| | | min | | | |
| CF₄ + H₂ + | 400° C./4 h | CF₄ (10 sccm) + | 1.27 | No F | Improved selectivity; |
| Ar | oxide | H₂ (8 sccm) + Ar | | residues | etch rate from |
| | | (2 sccm); 500 W | | | profilometry |
| | | ICP; 50 W bias; | | | |
| | | 20-50 mTorr; 15 | | | |
| | | min | | | |

### Example 2

Oxide Removal from C103 Powder Samples

### Materials/Methods

### 1. Reactor and Plasma Configuration

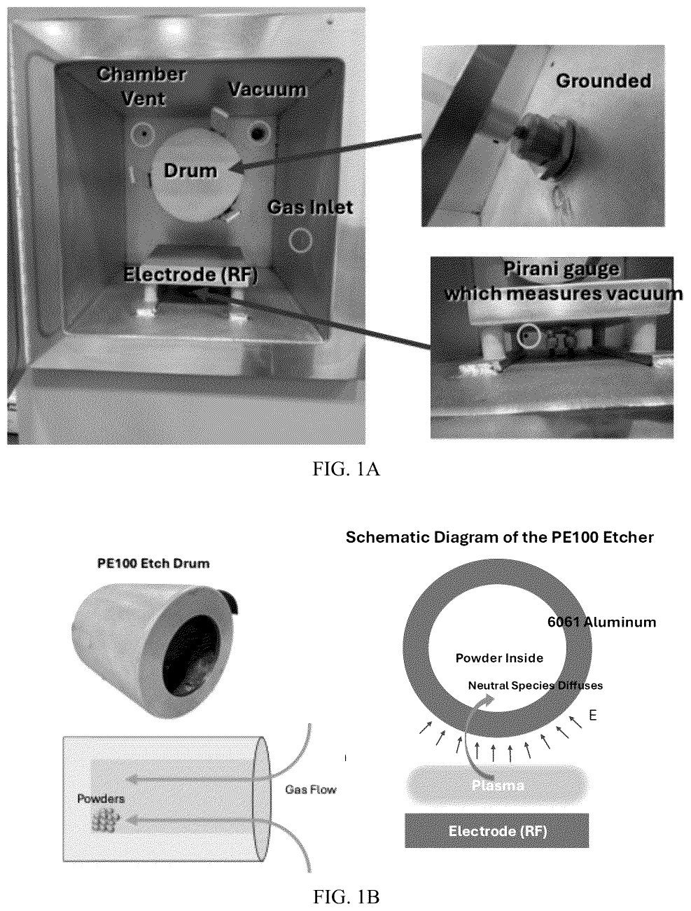

C103 powders were etched using a PE100 powder etcher specifically modified with a rotating drum assembly to enhance particle exposure to the plasma. The reactor setup is shown in FIGS. 1A and 1B. The reactor was operated at 250 W RF power, with chamber pressures corresponding to total flow rates of 4-10 sccm. The rotating drum (6061 Al, baffle-equipped) was typically operated at Level 2 (3.6 rpm) or Level 5 (37.5 rpm) to evaluate mixing uniformity. The chamber volume was about 34.22 L (12 in×14.5 in×12 in=2,088 in³).

### 2. Substrate Preparation

The powders consisted of oversized fractions collected from Build 1-7 C103 lots. Both as-received and pre-oxidized powders were tested. Oxidation was performed at 400° C. for 1 h in air to generate surface oxides before plasma treatment.

### 3. Etch Processes

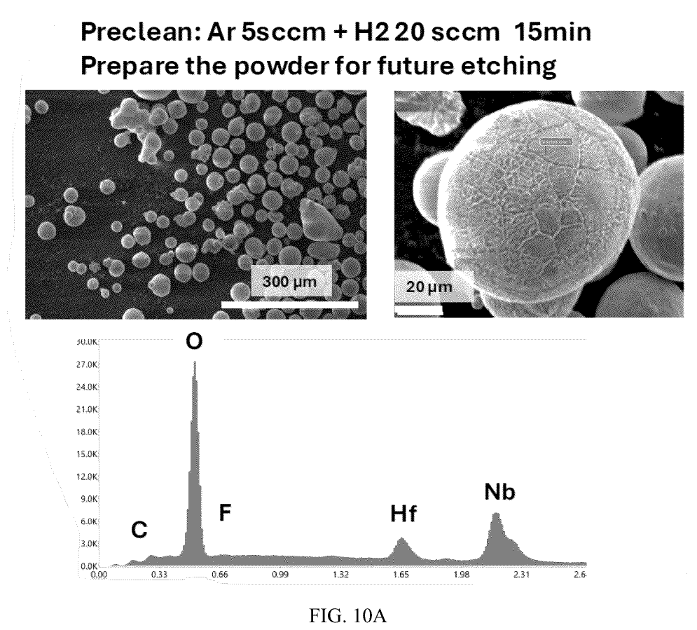

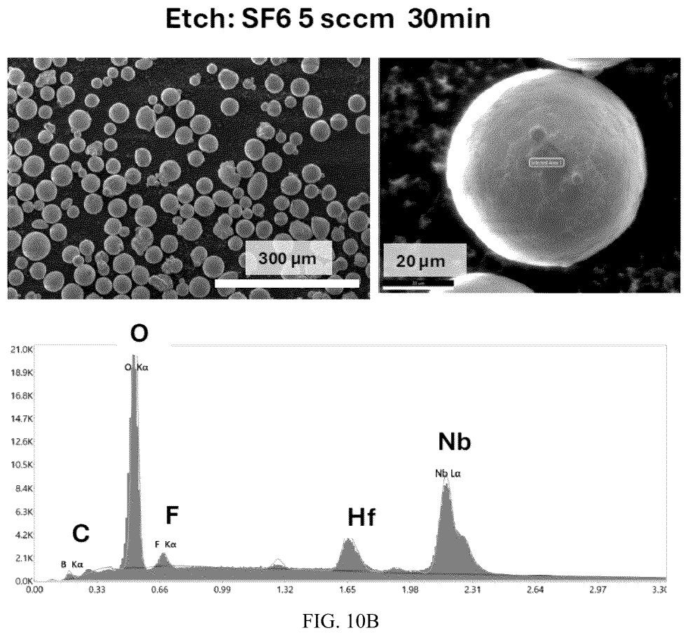

Etching recipes included (i) Ar+CF₄ mixtures, (ii) pure H₂ plasma, and (iii) SF₆ or Ar/SF₆ mixtures following Ar/H₂ pre-cleaning steps. Pre-cleaning (Ar 5 sccm+H₂ 20 sccm, 15 min) was used to reduce adventitious contaminants prior to the main etch. Etch times were typically 20-60 min, with extended tests up to 180 min for residue evaluation. FIG. 10A shows an example of a C103 oversized powder oxidized at 400° C. for 1 h after a preclean cycle (Ar 5 sccm+H₂ 20 sccm) for 15 minutes to prepare the powder for etching, and FIG. 10B shows an example after etching with SF₆ 5 sccm for 30 minutes.

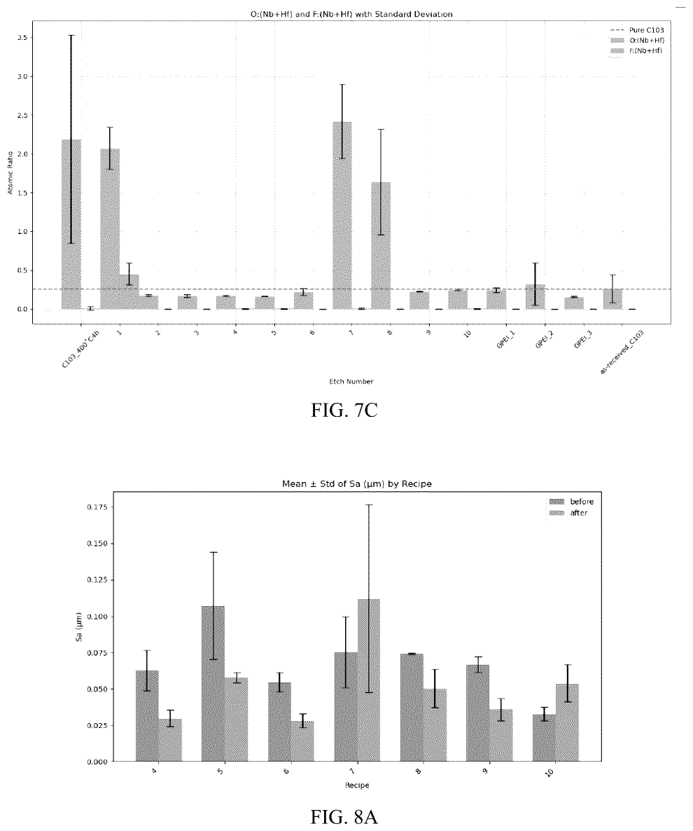

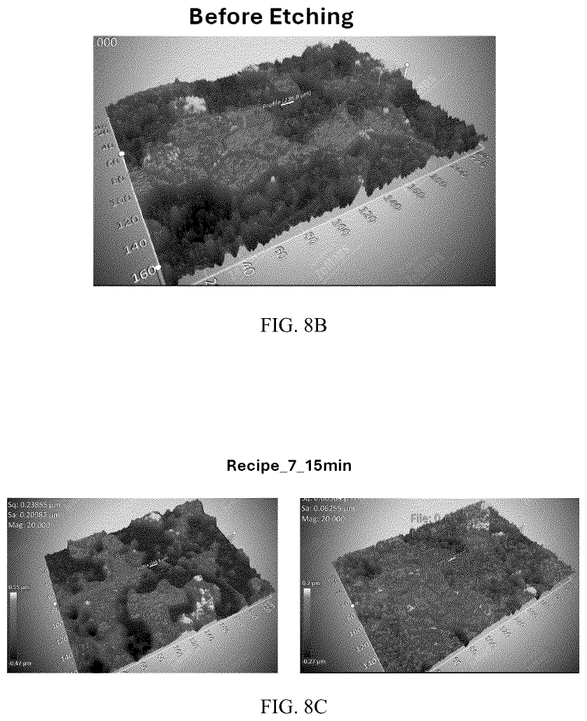

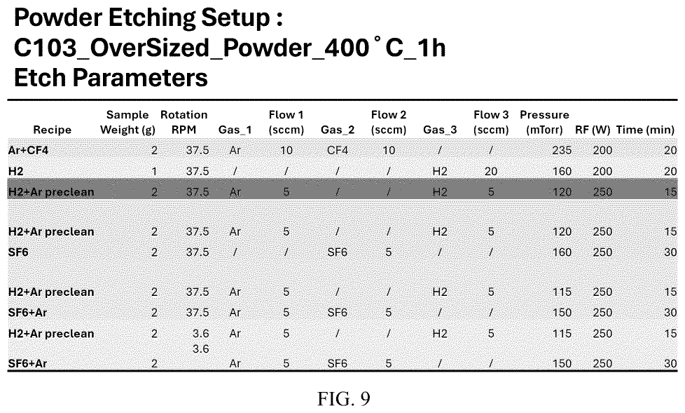

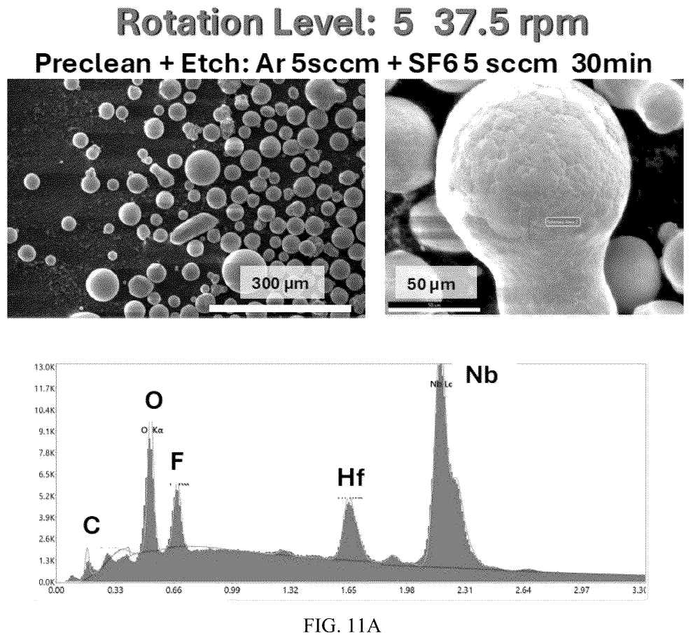

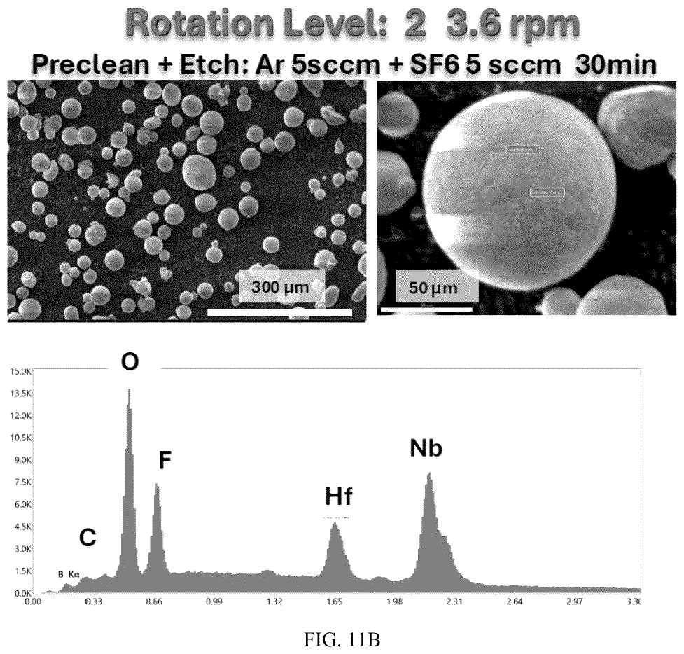

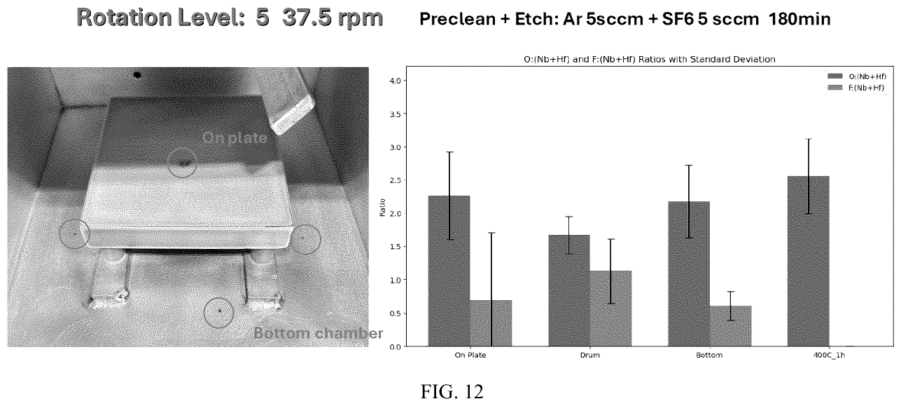

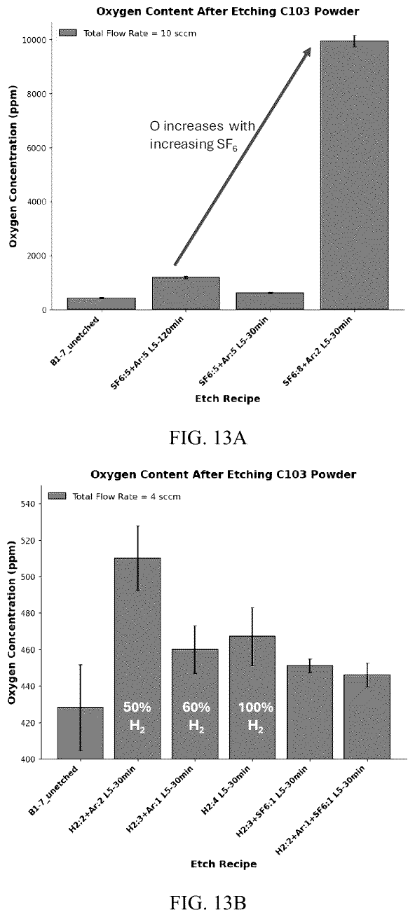

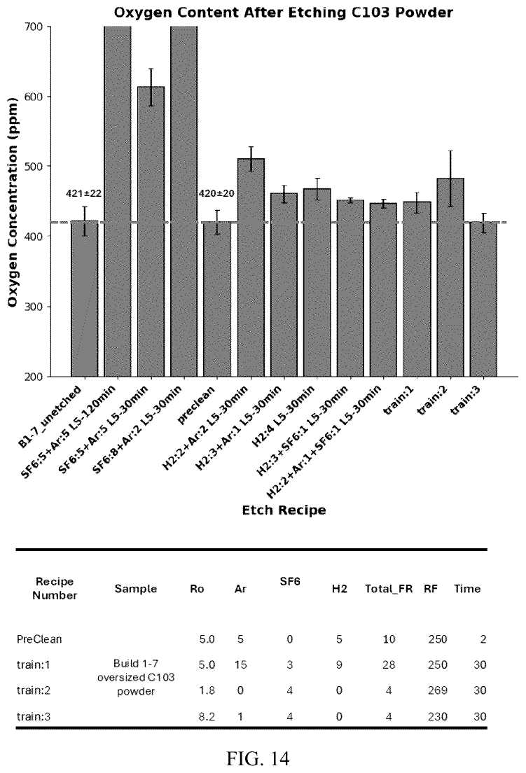

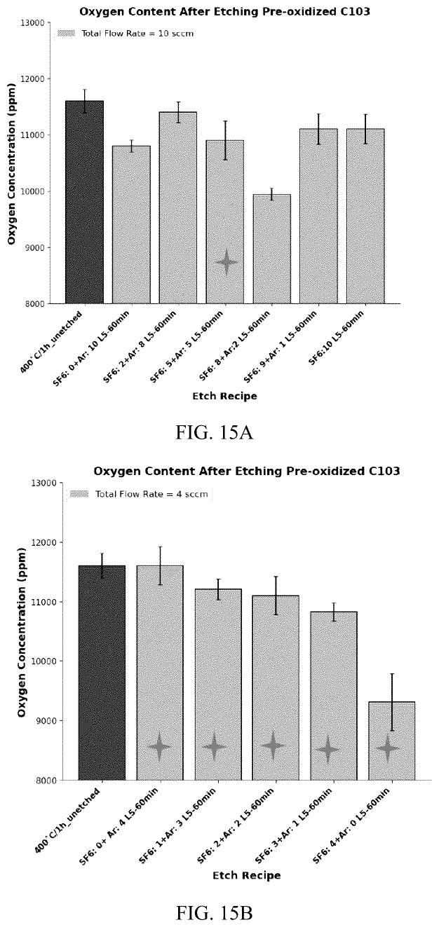

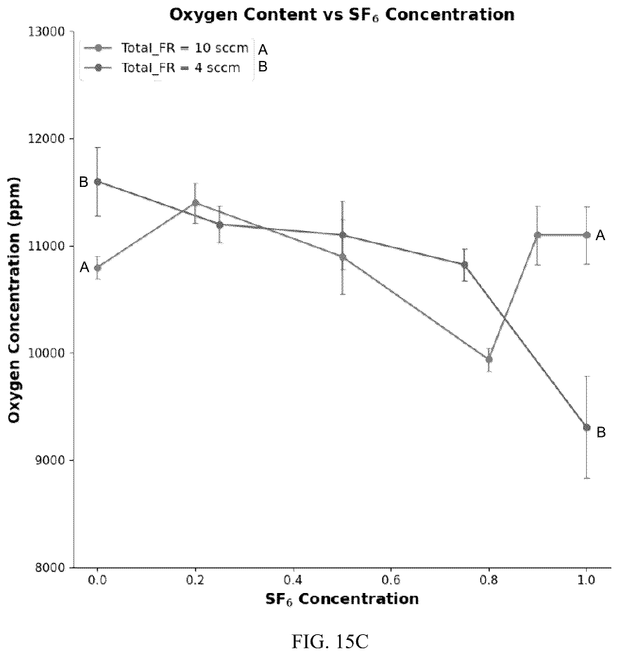

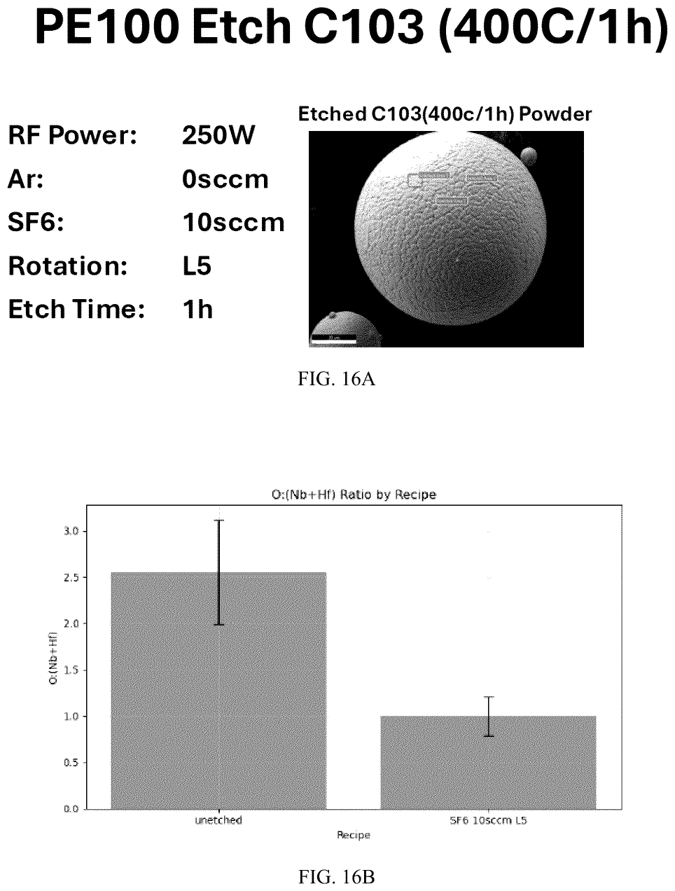

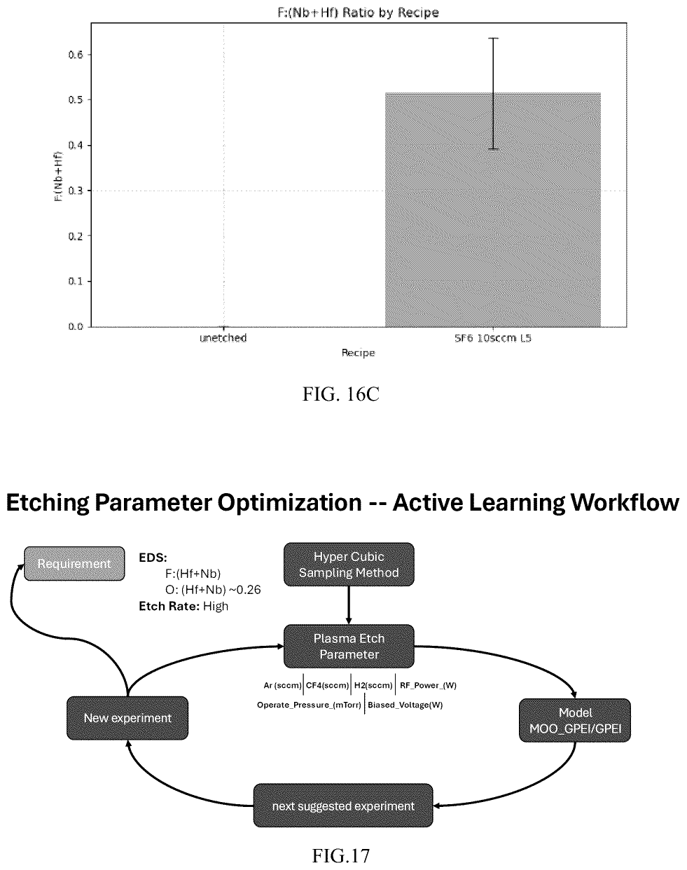

Parameters during the etching process were varied as shown in Table 3. For example, drum rotation speed was varied, as shown in FIGS. 11A and 11B. Samples from different locations in the processing chamber were analyzed, as shown in FIG. 8. Different etch recipes and flow rates were varied, as shown in FIGS. 13A, 13B, 14, 15A-15C, and 16A-16C.

### 4. Analysis Methods

Powders were characterized pre- and post-etch using SEM for morphology and EDS for elemental composition (Nb, Hf, O, F). Particle size and shape distributions were quantified by ImageJ image analysis across >1000 particles per condition. ON analysis was performed to measure oxygen content (ppm) and calculate oxygen removal rates. Fluorine contamination was tracked by normalizing F:(Nb+Hf) EDS ratios across conditions.

$$\begin{matrix}Oxides Removal Rate \\ ( ppm / min )\end{matrix} = \frac{400 ° C 1 {h}_{ppm} - {etched}_{ppm}}{etch time ( min )} \qquad ( 1 )$$

$$\begin{matrix}Time needed to convert \\ 400 ° C / 1 h back to as \\ recieved C 103\end{matrix} = \frac{400 ° C 1 {h}_{ppm} - Build 1 - 7 C {103}_{ppm}}{Oxides Removal Etch Rate ( ppm / min )} \qquad ( 2 )$$

### Results:

The results of the oxide removal experiments from C103 powder samples (ICP) are shown in Table 3 below.

TABLE 3

| Parameter | Increase | Decrease | Notes |
|---|---|---|---|
| Total Gas | ↓ Removal rate (shorter | ↑ Removal rate (longer | Residence time dominates |
| Flow | residence time, higher final | residence time, lower | transport chemistry |
| | O) | final O) | |
| SF₆ Fraction | ↑ then ↓ (max removal ~0.6- | ↓ Removal rate at low | Non-monotonic due to |
| (10 sccm total | 0.8 fraction, then rebound at | SF₆ concentration | electron density |
| flow) | 0.9-1.0) | | suppression at high SF₆ |
| SF₆ Fraction | ↑ Removal rate | ↓ Removal rate at lower | Long residence time |
| (4 sccm total | monotonically up to 100% | SF₆ concentration | avoids discharge quench |
| flow) | SF₆ | | issue |
| Rotation | ↑ Removal rate (better | ↓ Removal rate (less | Variance across particle |
| Speed | mixing, lower O, lower F | mixing, higher O, | sizes increases at high |
| | residue) | higher F residue)? | rotation (L5) |
| RF Power | ↑ Removal rate up to ~250- | ↓ Removal rate at too | Transport limits cause |
| | 300 W; plateau beyond | low RF power (<200 | diminishing returns |
| | | W) | beyond ~300 W |
| Etch Time | ↑ Total oxygen removed, but | ↓ Total removal if etch | Extended times effective |
| | higher F residue risk | time shortened | but risk fluorine |
| | | | contamination |

### Example 3

### Active Learning Workflow-Parameter Optimization

### 1. Computational Framework

An active learning workflow was developed to optimize plasma etching parameters for C103 powders (FIG. 17). The optimization framework was implemented using the Ax platform (Meta/Adaptive Experimentation), running on a workstation with Python 3.11. Models were based on Gaussian Process Regression (GPEI), which enabled efficient exploration of high-dimensional design spaces while handling limited experimental datasets.

### 2. Sampling Strategy.

Initial etching experiments were selected by Latin Hypercube Sampling (LHS) to ensure broad coverage of the parameter space. Each recipe included four key input variables:
RF Power (W),
Gas Flow Rates (Ar, SF₆, H₂ or CF₄, in sccm),
Drum Rotation Level (dimensionless, L0-L5),
Etch Time (min).

### 3. Experimental Data.

C103 oversized powders (Build 1-7) were pre-oxidized at 400° C. for 1 h in air to ensure reproducible surface oxides. These powders were etched in the PE100 CCP-RIE powder etcher.

The measured outputs were:
Oxygen concentration (ppm) from ON analysis,
Oxygen removal rate (ppm/min),
EDS elemental ratios (O:(Nb+Hf), F:(Nb+Hf)).

These results served as the feedback for the Bayesian optimization loop.

### Optimization Objective.

The active learning framework was trained to minimize oxygen content (ppm) and fluorine residue, while maintaining high etch rates. Each iteration proposed 3-5 new parameter sets based on posterior predictions, which were then experimentally tested.

1. A method of removing an oxidized material from an oxidized substrate comprising a base material and the oxidized material, the method comprising:
generating a plasma from a processing gas; and
contacting the oxidized substrate with the plasma, thereby removing the oxidized material from the oxidized substrate to provide an etched substrate,
wherein the oxidized substrate comprises a transition metal or an alloy thereof.

2. The method of claim 1, wherein the transition metal or an alloy thereof comprises iridium, osmium, niobium, molybdenum, tantalum, tungsten, rhenium, rhodium, ruthenium, hafnium, titanium, vanadium, zirconium, chromium, or any combination thereof.

3. The method of claim 1, wherein the oxidized substrate is a bulk substrate or a powder substrate.

4. The method of claim 1, wherein the oxidized substrate is disposed on a stage configured to hold the oxidized substrate.

5. The method of claim 4, wherein the stage is a stationary planar surface or a rotatable drum.

6. The method of claim 5, wherein the step of contacting the oxidized substrate with the plasma comprises rotating the rotatable drum at a speed of about 1 rpm to about 100 rpm.

7. The method of claim 1, wherein the processing gas comprises a fluorine gas, a non-reactive gas, or a combination thereof.

8. The method of claim 7, wherein the processing gas has a Global Warming Potential (GWP) of less than about 20,000.

9. The method of claim 1, wherein the step of generating a plasma comprises:
providing the processing gas to a processing chamber, and
applying a radiofrequency (RF) power to an electrode and/or an inductive coil coupled to the processing chamber, thereby generating an electric field and forming the plasma.

10. The method of claim 1, wherein the step of contacting the oxidized substrate with the plasma is performed at a pressure of about 1 mTorr to about 500 mTorr.

11. The method of claim 1, wherein the oxidized substrate is in contact with the plasma for about 1 second to about 300 minutes.

12. The method of claim 1, wherein the oxidized substrate has an oxygen content prior to the step of contacting the oxidized substrate, and the step of contacting the oxidized substrate reduces the oxygen content of the oxidized substrate.

13. The method of claim 1, wherein the etched substrate comprises a fluoride material disposed on the base material.

14. The method of claim 1, further comprising a step of contacting the etched substrate with a finishing plasma.

15. The method of claim 1, further comprising a step of predicting an etching parameter using an active learning method based on a measured property, and performing one or more steps of the method using the predicted etching parameter.

16. A system for removing an oxidized material from an oxidized substrate comprising a base material and the oxidized material, the system comprising:
a processing chamber configured to provide an etched substrate from the oxidized substrate,
a gas inlet configured to supply a processing gas into the processing chamber,
a radiofrequency (RF) power supply configured to supply radio-frequency power to an electrode and/or an inductive coil for generating a plasma from the processing gas, and
a stage configured to hold the oxidized substrate,
wherein each of the gas inlet, the RF power supply, the electrode, the inductive coil, and the stage is independently coupled to the processing chamber, and
wherein the oxidized substrate comprises a transition metal or an alloy thereof.

17. The system of claim 16, wherein the stage is a stationary planar surface or a rotatable drum.

18. The system of claim 16, wherein the processing gas comprises a fluorine gas, a non-reactive gas, or a combination thereof.

19. The system of claim 16, wherein the oxidized substrate is a bulk substrate or a powder substrate.

20. The system of claim 16, wherein the transition metal or an alloy thereof comprises iridium, osmium, niobium, molybdenum, tantalum, tungsten, rhenium, rhodium, ruthenium, hafnium, titanium, vanadium, zirconium, chromium, or any combination thereof.
